(19) United States
(12) Patent Application Publication
(10) Pub. No.: US 2009/0199726 A1
(43) Pub. Date: Aug. 13, 2009

(54) AVOCADO DE-SKINNING APPARATUS

(76) Inventor: Richard MOORE, Chula Vista, CA (US)

Correspondence Address: FRANK G MORKUNAS, 7750 DAGGET ST, SUITE 203, SAN DIEGO, CA, 92111, US

(21) Appl. No.: 12/423,356

(22) Filed: Apr. 14, 2009

Related U.S. Application Data
(63) Continuation-in-part of application No. 11/845,184, filed on Aug. 27, 2007.
Application No. 11/845,184 is a continuation-in-part of application No. 11/280,068, filed on Nov. 16, 2005, now Pat. No. 7,444,930.

(51) Int. Cl. A47J 17/14; A23N 7/00; A47J 17/18

(52) U.S. Cl. 99/593; 99/584

(57) ABSTRACT

An avocado de-skinning apparatus having two vertically disposed rotating drums which rotate inward. The drums each have axial grooves which are perpendicular to the axis of the drums and intersecting cross grooves which are perpendicular to the axial grooves and parallel to the axis of the drums. The rotating drums pinch off the skin of an avocado and force it through a drum gap between the rotating drums. The avocado pulp drops off for further processing. A skin scraper at the rear of the rotating drums removes skin adhering to the drums and a pulp scraper [doctor blade] to the front, with ends which corresponds to the shape of the axial grooves, biases onto the axial grooves and scrapes off any pulp adhering to the drums for further processing.

### CROSS REFERENCES TO RELATED APPLICATIONS

This application is a continuation-in-part of nonprovisional application, application Ser. No. 11/845,184, filed on Aug. 27, 2007, which was a continuation-in-part of nonprovisional application, application Ser. No. 11/280,068, filed on Nov. 16, 2005, now U.S. Pat. No. 7,444,930 which issued on Nov. 4, 2008.

### STATEMENT REGARDING FEDERALLY-SPONSORED RESEARCH OR DEVELOPMENT

Not applicable.

### BACKGROUND

This present invention relates to an improvement in removing skin and pulp from avocados and more particularly to retrieving more usable pulp from the avocado for processing.

Avocados have become more and more popular for their versatility and arguable health-related benefits. They come in various varieties and sizes. For example, West Indian avocados produce enormous, smooth round, glossy green fruits that are low in oil and can weigh up to two pounds. Guatemalan types produce medium ovoid or pear-shaped, pebbled green fruits that turn blackish-green when ripe. The fruit or pulp of Mexican varieties are smaller (six to ten ounces) with skins that turn glossy green or black when ripe.

Regardless the pulp of avocados is deep green near the skin, becoming yellowish nearer the single large, inedible ovoid seed. The pulp is hard when harvested but softens to a buttery texture. Avocados are high in monosaturates and the oil content is second only to olives among fruits. Clinical feeding studies in humans have shown that avocado oil can reduce blood cholesterol.

In many cases, fruits (such as avocados) and vegetables are more easily de-skinned by the heating of these foods. Such heating does not adversely affect the flavor, texture, or appearance of most such foods. Processing avocados by first heating for the purpose of de-skinning them, however, is not nutritionally sound. Avocados are a fruit which is extremely sensitive to heat. This is particularly so in its green (chlorophyll) layer of its pulp as it lies immediately below the skin and, consequently, is subject to greatest heat exposure and nutritional loss and flavor loss. Additionally, avocado skins are particularly thick and/or rough and most processing techniques are manual or if mechanized, the apparatus is expensive, complex, and not as efficient as desired in that usable pulp is lost in the process.

Because of their popularity and growing popularity, and commercialization of avocados, a need existed to effectively and efficiently remove the pulp from an avocado for processing regardless of the size or type of avocado being processed. The prior art has numerous de-skinning or peeling machines and pulp or fruit removal machines which have been cited in this application. Most are extremely complex, somewhat cumbersome, and costly to manufacture and maintain. None is as simple as the apparatus described in my pending application nor as the apparatus described herein which is an improvement to the apparatus of my pending application. In spite of the seeming simplicity of both each apparatus, none of the prior art devices is as efficient or effective.

The objects of the presently described apparatus are to:

a. effectively and efficiently guide an avocado into a de-skinning apparatus for de-skinning the avocado.

b. effectively and efficiently de-skin an avocado and dispose of the unwanted skin.

c. effectively and efficiently remove the pulp from an avocado and retrieve the pulp for later use.

d. effectively and efficiently remove avocado skin remnants remaining on the apparatus to thereby prevent the skin remnants from mixing with the removed pulp.

e. effectively and efficiently remove pulp remnants remaining on the apparatus to thereby increase the usable volume of pulp.

The foregoing has outlined some of the more pertinent objects of the presently described apparatus. These objects should be construed to be merely illustrative of some of the more prominent features and applications of the intended and presently described apparatus. Many other beneficial results can be attained by applying the presently described apparatus in a different manner or by modifying the presently described apparatus within the scope of the disclosure. Accordingly, other objects and a fuller understanding of the presently described apparatus may be had by referring to the summary and the detailed description of the preferred embodiment in addition to the scope of the presently described apparatus as defined by the claims taken in conjunction with the accompanying drawings.

### BRIEF SUMMARY OF THE INVENTION

The above-noted problems, among others, are overcome by the presently described apparatus. Briefly stated, the presently described apparatus contemplates an avocado de-skinner having two generally vertically disposed rotating drums which rotate inward. The drums each have axial grooves which are generally perpendicular to the axis of the drums and intersecting cross grooves which are generally perpendicular to the axial grooves and parallel to the axis of the drums. The rotating drums pinch the skin of an avocado and force it off the avocado and through a drum gap which is between the rotating drums. After the avocado is de-skinned, its pulp drops off for further processing. A skin scraper at the rear side of the rotating drums removes the skin adhering to the drums. A pulp scraper [doctor blade] to the front of the skin scraper has ends which corresponds to the shape of the axial grooves, biases onto the axial grooves, and scrapes off any pulp adhering to the drums for further processing.

The foregoing has outlined the more pertinent and important features of the presently described apparatus in order that the detailed description thereof which follows may be better understood so the present contributions to the art may be more fully appreciated. Additional features of the presently described apparatus will be further described hereinafter and which will form the subject of the claims. It should be appreciated by those skilled in the art that the conception and the disclosed specific embodiment may be readily utilized as a basis for modifying or designing other structures and methods for carrying out the same purposes of the presently described apparatus. It also should be realized by those skilled in the art that such equivalent constructions and methods do not depart from the spirit and scope of the presently described apparatus as set forth in the appended claims.

### BRIEF DESCRIPTION OF THE DRAWINGS

For a fuller understanding of the nature and objects of the presently described apparatus, reference should be had to the following detailed description taken in conjunction with the accompanying drawings in which:

FIG. 1 is perspective view of the apparatus.

FIG. 2 is a top plan view of the apparatus.

FIG. 3, as taken on line 3-3 of FIG. 2, is a detailed side view of the apparatus.

FIG. 4 is a side view of the apparatus.

FIG. 5 is a detailed view of the guide plate for the apparatus.

FIG. 6 is a side elevation view of the improved apparatus of the present disclosure.

FIG. 7 is a detailed view of the registration plate of the improved apparatus.

FIG. 8 front elevation view of a drum of the improved apparatus.

FIG. 9 as taken on line 9-9 of FIG. 8 is a top plan partial view of a drum of the improved apparatus.

FIG. 10 is a detailed view of section W on FIG. 8 of a drum.

FIGS. 11 and 12 are detailed views of the peaks and grooves of a drum of the improved apparatus wherein the grooves are curvilinear.

FIG. 13 is a detailed view of the peaks and grooves of a drum of the improved apparatus wherein the grooves are relatively straight cuts with defined angles.

### DETAILED DESCRIPTION OF THE INVENTION

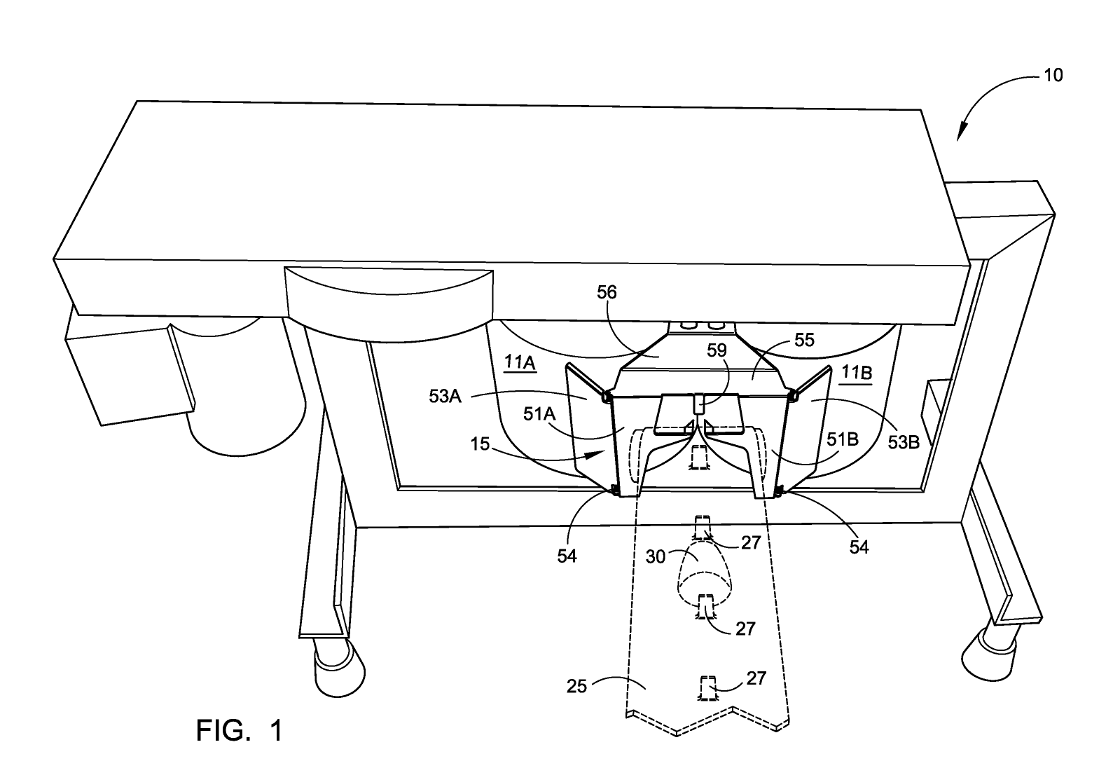

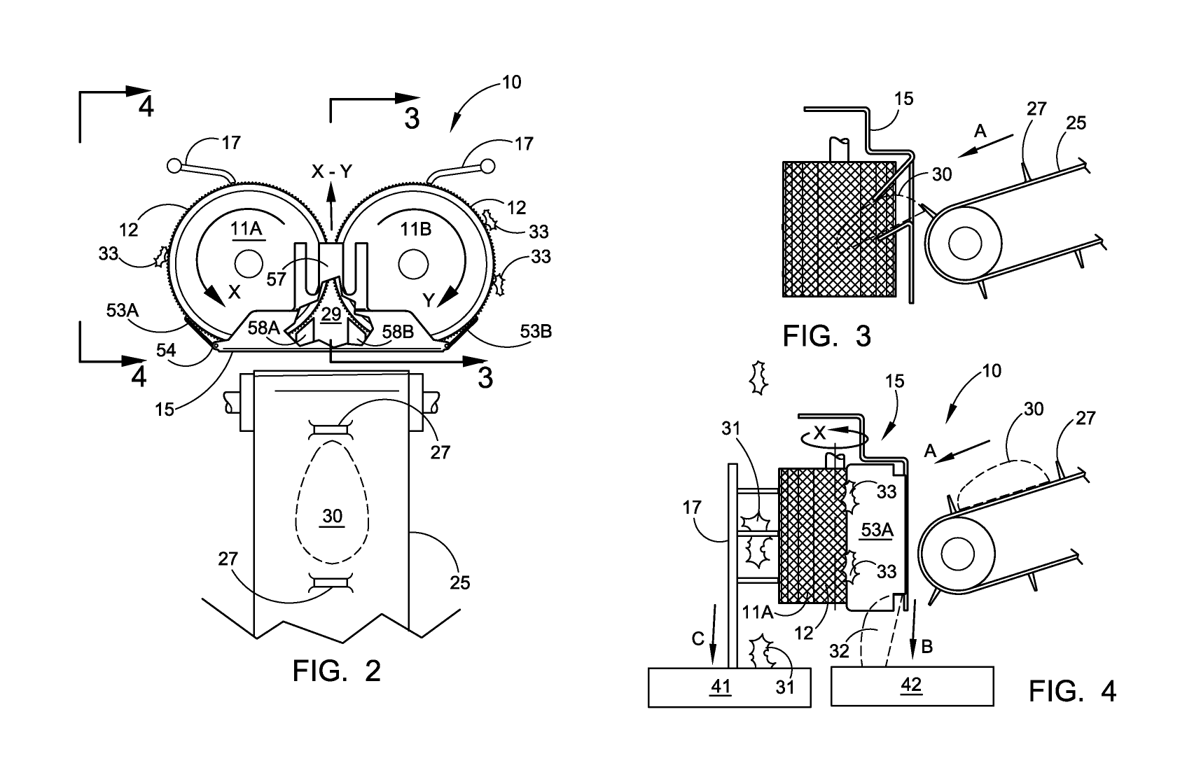

FIGS. 1 through 5, reference character 10 generally designates an avocado de-skinning apparatus constructed in accordance with a preferred embodiment of my previous applications and is provided herein to aid in administrative clarity when describing the improved apparatus as illustrated in FIG. 6-13.

In my prior applications, two upstanding, generally vertically disposed, drums 11A, 11B are adjacent to one another but do not touch. A gap 29 is formed at their point of adjacency. The drums 11A, 11B are rotated in tandem in the directions of Arrows X, Y, respectively.

A conveyer belt 25 with upstanding fins 27 retain and guide an avocado 30 to the apparatus 10 and into the guide plate 15. An avocado sits between two fins 27. For the purpose of discussion, the fin at the front of the avocado is the leading fin and the fin at the rear of the avocado is the trailing fin. The trailing fin pushes the avocado into the guide plate 15 and to the drums 11A, 11B which have a triangular-like opening or gap 29. Once forced into the gap 29 and the rotating drums 11A, 11B, the avocado will be de-skinned. FIGS. 3 and 4 illustrate the movement of an avocado 30 and the processing.

An avocado 30 may be pre-prepared by having been cut in half and the pit may, but need not have been, removed. In the embodiment of the apparatus as illustrated in FIGS. 1-4, the pit should generally be removed prior to the avocado 30 being conveyed to the drums 11A, 11B

A conventional motor with suitable gears and shafts (not shown) are connected to the drums 11A, 11B to effect the rotation of the drums. Similarly, a conventional motor (not shown) is connected to the conveyor belt 25 to effect the movement of the conveyor belt 25 and avocados in the direction of Arrow A.

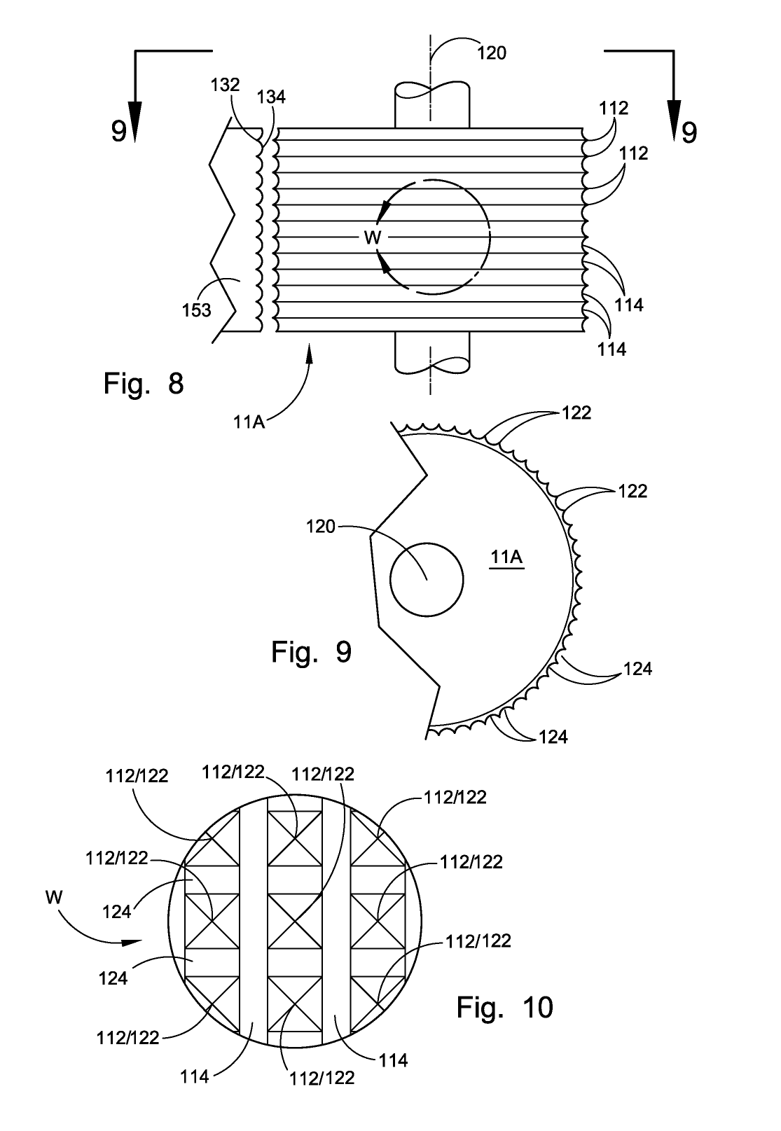

For best efficiency, the drums 11A, 11B are roughened or knurled 12. FIGS. 8-12 illustrate the most efficient and improved type of knurling concept associated with these drums 11A, 11B as set forth in my current application and which will be described in detail later. The rotating knurled drums 11A, 11B grab the skin 31 off the avocado 30 and pull the skin 31 through the rotating drums 11A, 11B, in the direction of Arrow XY until, at the rear of the drums 11A, 11B the skin 31 falls out and down in the direction of Arrow C into a suitable skin disposal unit 41 for ultimate disposition.

As the skin 31 is being removed by the gap/drum combination 29, 11A, 11B at the front of the drums 11A, 11B, most of pulp remains for retrieval. After de-skinning therefore, the whole pulp 32 falls down in the direction of Arrow B and into a suitable pulp retrieval unit 42. An residual pulp 33 may adhere to the drums 11A, 11B but will be scraped off and likewise retrieved.

In my prior applications, a skin de-scaler 17, generally a pronged scraper, is located at the rear of each drum 11A, 11B to remove any skin 31 which does not fall down and into the skin disposal unit 41 of its own accord to thereby remove the skin 31 from the surface of the respective drum and allow it to drop into the skin disposal unit 41.

Also in the prior applications, a doctor or blade or pulp scraper 53A, 53B, on the guide plate 15 at the front of the drums 11A, 11B, captures and removes any pulp adhering to the respective drum and thereby permit the pulp to fall into the pulp retrieval unit 42. In my current application of the improved apparatus I have greatly modified the structure of the guide plate and pulp scraper and consequently improved the functionality and efficacy of the avocado de-skinning apparatus.

As configured in my prior applications, the skin disposal unit 41 is below and to the rear of the drums 11A, 11B and below the scraper 17. The pulp retrieval unit 42 is below the gap 29 to the front of the drums 11A, 11B and below the doctor 53A, 53B of the guide plate 15.

The gap 29 may be of any width suitable for the intended purpose but a width ranging from approximately 1/12 of an inch to approximately ¼ of an inch will produce good results but a width range from approximately ⅛ of an inch to approximately ⅙ of an inch will produce better and more effective and efficient results. If the gap 29 is too narrow, part of all of the skin 31 will not be forced through the gap 29. If the gap 29 is too wide, it will cause some or all of the whole pulp 32 therethrough.

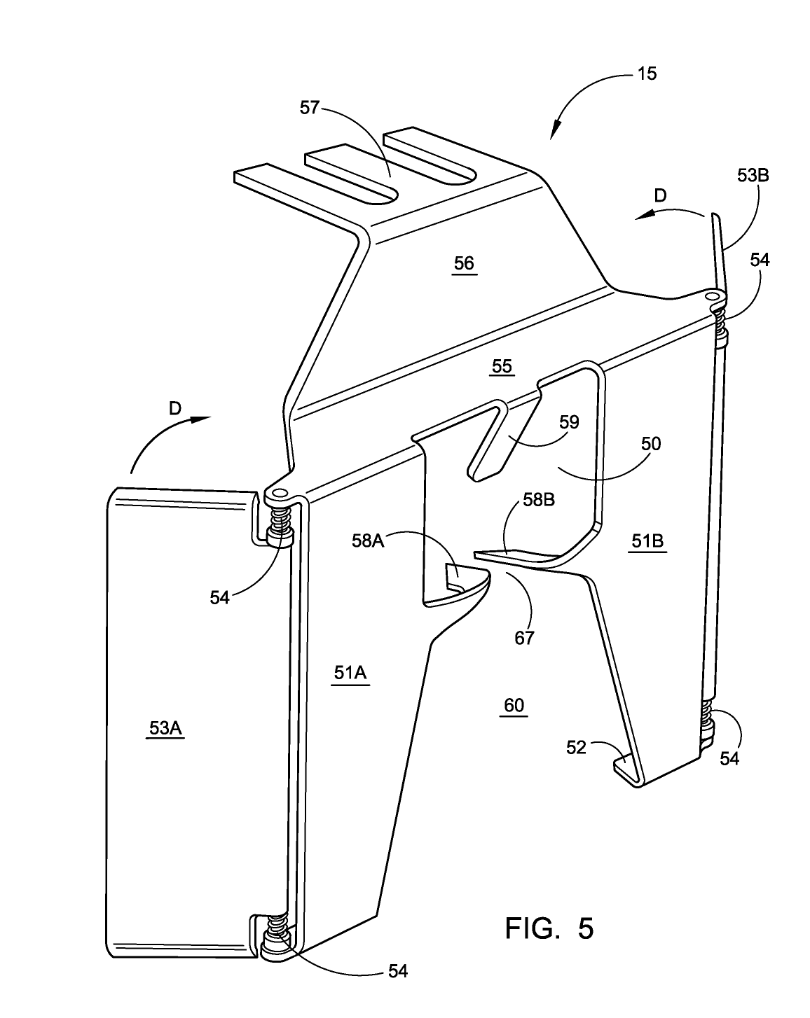

FIG. 5 illustrates the detail of the guide plate 15 of my prior application. The guide plate 15 in the lynch-pin to the registration and feeding an avocado 30 into the apparatus for de-skinning. The top plate section 55 has an upward extending section 56 with rearward extending fingers 57 for a secure mounting and attachment of the guide plate 15 to the apparatus.

A plate front member 51A, 51B extends downward from the top plate section 55. This is a two-piece section consisting of a left side section 51A and a right side section 51B. The outer edges of each side section 51A, 51B each have a respective side member 53A, 53B which are pivotably and biased attached to their respective front side sections 51A, 51B by a biasing component 54. The force of the biasing is in the direction of each adjacent drum 11A, 11B [arrow D] such that the side members 53A, 53B are forced to the drums 11A, 11B and serve as a doctor blade to scrape any residual pulp 33 adhering to the drums 11A, 11B as they rotate from previously de-skinned avocados.

A central space is defined between the left side section 51A and the right side section 51B. An upper guide arm 59 extends downward and inward from the plate top section 55. A left side guide arm 58A extends inward from the left side section 51A and rearward of the left side section 51A toward the drums 11A, 11B. Similarly right side guide arm 58B extends inward from the right side section 51B and rearward of the right side section 51B toward the drums 11A, 11B.

Each such guide arm 58A, 58B is substantially below the upper guide arm 59 and by such configuration defines a first gap 50 in the space. A second gap 60 is defined below the first gap 50. The two guide arms 58A, 58B do not touch but leave a guide space 67 therebetween of sufficient width as to permit the passage of the fins 27 of the conveyor belt 25. Consequently, as the conveyor belt 25 is bringing avocados to the apparatus 10, the conveyor belt 25 passes into the second gap 60 and the fins 27 pass through the guide space 67. In the process the avocado 30 is pushed into the first gap 50. The upper guide arm 59 and side guide arms 58A, 58B register the avocado 30 for a proper receipt thereof into the rotating drums 11A, 11B for de-skinning.

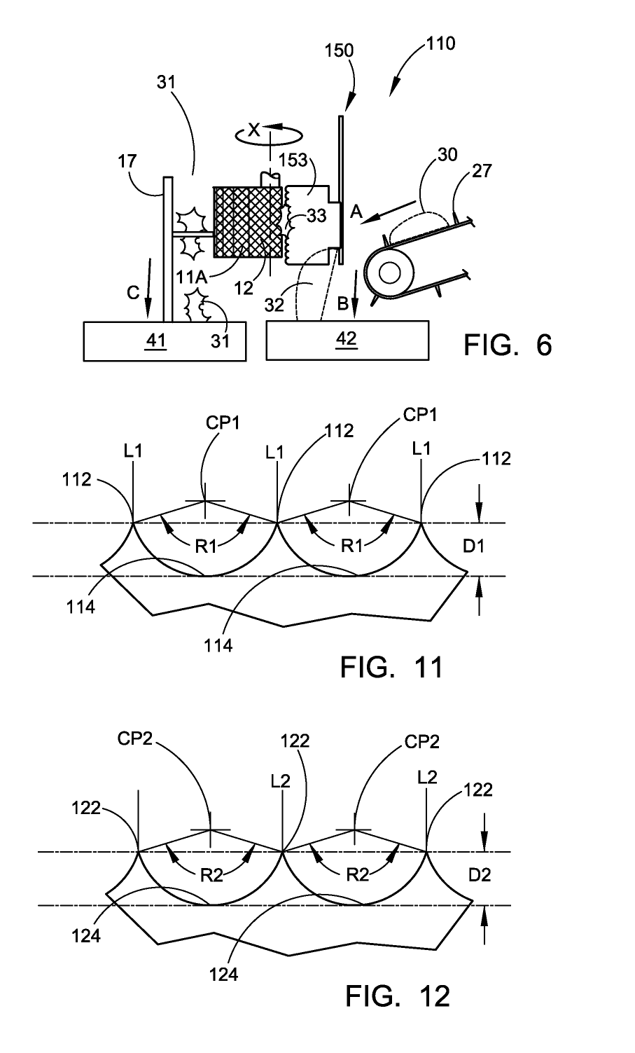

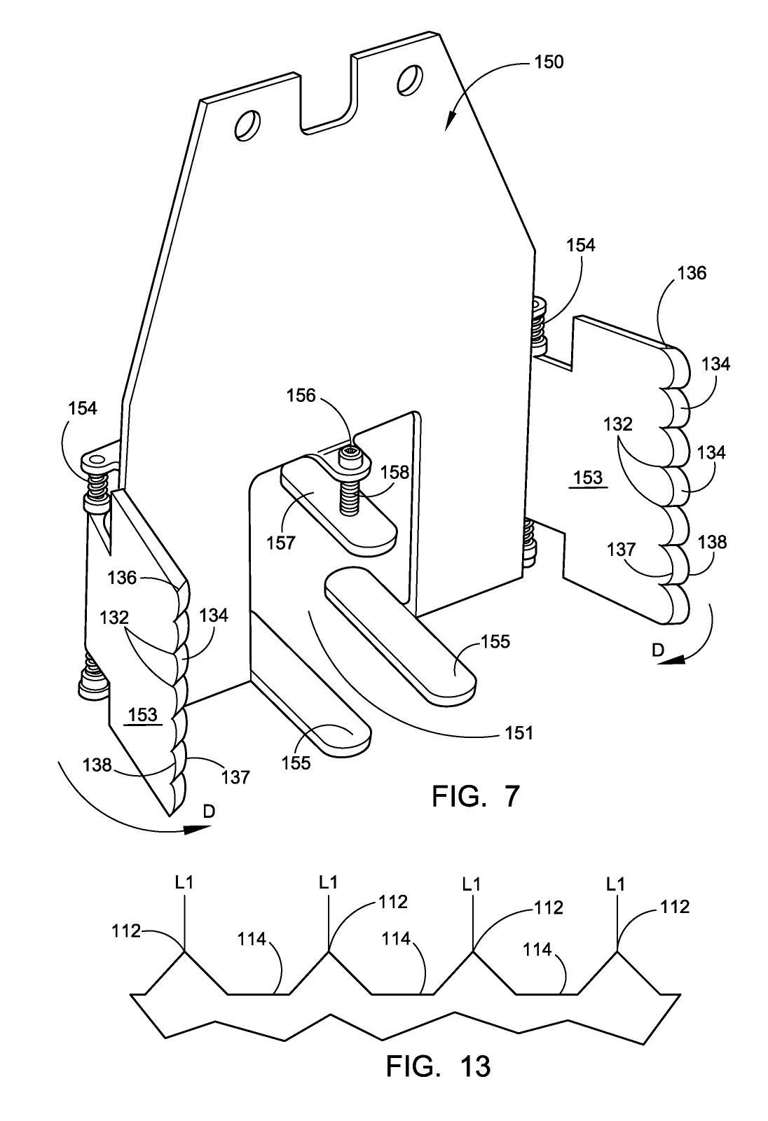

In my current application the major improvements include a modified guide plate 150 [See FIG. 7] and the knurling concept which is best illustrated in FIGS. 8-13. FIG. 6 is a representation of the combination of these improvements associated with the improved apparatus 110 which generally functions in peel and pulp removal as described above but more efficiently for the reasons and description set forth below.

The knurling concept associated with these drums 11A, 11B of this present disclosure illustrate clearly defined peaks 112 and grooves 114 [axial peaks and axial grooves respectively] which are generally perpendicular to the axis 120 and peaks 122 and grooves 124 [cross peaks and cross grooves respectively] which are generally perpendicular to the axial grooves 114 and generally parallel to the axis 120.

Referring to FIGS. 11 and 12, the axial groove 114 of FIG. 11 is illustrated as a radial groove [relatively curvilinear] and is represented by reference character R1 wherein R1 is a radial angle from its center point [CP1] from one axial peak 112 to the next adjacent axial peak 112. The depth of the axial groove 114 is represented by reference character D1 [or Depth-D1].

In this embodiment, for good results, the radial angle for R1 should range from approximately 115° to approximately 130° and the depth [Depth-D1] should range from approximately 0.020-inches to approximately 0.080-inches. The distance from one axial peak 112 to the next adjacent axial peak 112 [referred to as length-L1] should ranges from approximately 0.060-inches to approximately 0.250-inches. Best results are achieved when the radial angle R1 is approximately 123°, the depth D1 is approximately 0.034 to 0.035-inches, and the distance from axial peak 112 to the next adjacent axial peak 112 [L1 to the next adjacent L1] is approximately 0.110-inches; or where the ratio between D1 to L1 is approximately 1:3.

The cross grooves 124 of FIG. 12 [also illustrated to be radial grooves] is represented by reference character R2 wherein R2 is a radial angle from its center point [CP2] from one cross peak 122 to the next adjacent cross peak 122. The depth of the cross groove 124 is represented by reference character D2 [or Depth-D2]. For good results, the radial angle for R2 should range from approximately 115° to approximately 130° and the depth [Depth-D2] should range from approximately 0.020-inches to approximately 0.080-inches but should generally be less than D1. The distance from one cross peak 122 to the next adjacent cross peak 122 [referred to as length-L2] should range from approximately 0.060-inches to approximately 0.250-inches. Best results are achieved when the radial angle R2 is approximately 123°, the depth D2 is approximately 0.033-inches [and less than D1], and the distance from cross peak 122 to the next adjacent cross peak 122 is approximately 0.110-inches; or where the ration between D2 to L2 is approximately 1:3.

The grooves 114, 124 as discussed above are radial but need not be. FIG. 13 illustrates that the respective grooves 114, 124 may be relatively straight-cut and may bear more than one angle and more than one cut. For administrative efficiencies FIG. 13 illustrates 3 relatively straight cuts bearing 2 angles but there could be 2 such cuts [V-like] with 1 angle, or 4 such cuts with 3 angles, or 5 such cuts with 4 angles, and the like.

It should be noted that the shape of the groove/cut is not as important as the respective depth in that D1 [axial groove 114], for more efficient scraping of residual pulp, should be deeper than D2 [cross groove 124].

It also does not matter in manufacture which grooves [axial 114 or cross 124] are cut first, for discussion purposes if the axial grooves 114 are cut first the axial peaks 112 stand alone. Once the cross grooves 124 are cut, the cross peaks 122 and adjacent axial peaks 112 should basically become one and the same peak and thereby share the same termination point. For best operation and functionality of the drums 11A, 11B with the axial peaks 112, axial grooves 114, cross peaks 122, and cross grooves 124, as mentioned above the axial groove 114 should generally be cut deeper into the drum 11A, 11B than the cross groove 124 and generally the axial peaks 112 and the cross peaks 122 should be one and the same as best illustrated in FIG. 10. Naturally to accomplish the shared peak, because the axial groove 114 is more deeply cut, the width of the cut for the cross groove 124 should be slightly greater than the width of the cut for the axial groove 114.

The operation of the improved apparatus is similar to my previously described apparatus of my prior applications [refer to FIGS. 4, 6, and 7], though in my improved apparatus 110, the conveyor 25 has been lowered. This along with a smaller doctor blade 153 on each side of the guide plate 150 as a left side member and a right side member, respectively, and smaller drums 11A, 11B, facilitates manufacture and efficiency of operation.

As the avocado 30 is being forced into the opening 151 of the guide plate 150, the rotating drums 11A, 11B, with axial groove 114 and cross groove 124 knurling, grab the skin 31 off the avocado 30 and pull the skin 31 through the rotating drums 11A, 11B, in the direction of Arrow XY until, at the rear of the drums 11A, 11B the skin 31 falls out and down in the direction of Arrow C into a suitable skin disposal unit 41 for ultimate disposition.

As the skin 31 is being removed most of pulp remains for retrieval. After de-skinning therefore, the whole pulp 32 falls down in the direction of Arrow B and into a suitable pulp retrieval unit 42. An residual pulp 33 may adhere to the drums 11A, 11B but will be scraped off and likewise retrieved by the doctor blade 153. Each doctor blade 153 has a near edge which is pivotably and biasedly connected to each side of the guide plate, and a top, a bottom, and a far edge 136 with ends 132, 134 which conform to the contours of the axial peaks 112 and axial grooves 114 of the drums 11A, 11B [See FIGS. 7-8].

In embodiments using radial cuts for the axial grooves 114, this doctor blade 153 has scalloped far ends 134 which are in communication with the axial grooves 114 of the drum 11A and the grooves 132 of this doctor blade 153 are in communication with the axial peaks 112 of the drum 11A.

In embodiments using straight cuts for the axial grooves 114, the ends of the doctor blade 153 are configured to match and mate with the axial grooves 114 of the drum 11A and the grooves 132 of this embodiment of doctor blade 153 are in communication with the axial peaks 112 of the drum 11A. This matching and mating, along with the axial groove 114 being more deeply cut than the cross groove 124 allow for a more efficient removal of residual pulp and, in the process, maximize quantity of pulp retrieved.

An additional feature associated with the doctor blade 153 is the far edge 136, which is an angled edge, of each blade and is best illustrated in FIG. 7. As shown in this figure, the doctor blades 153 are facing inward and toward the drums 11A, 11B. The outer pointed end 138 has an acute angle and the inner end 137 has an obtuse angle. It is the pointed end 138 which communicates directly with the drum 11A, 11B and thereby aids in the efficient scraping of residual pulp from the drums 11A, 11B.

As stated above, the doctor blade 153 of this improved apparatus is smaller than that which is illustrated in my prior applications as well as the drums 11A, 11B. As in my prior applications, this doctor blade 153 is on both sides [as a left side member and a right side member] of the guide plate 150 and each are biased attached thereto by a hinge 154 and biased to move in the direction of Arrow D. An opening 151 in the guide plate has two receiving support ledges 155 to receive and further guide an avocado entering through the opening 151. A vertically-adjustable upper support plate 157 stabilizes and facilitates movement of the avocado into communication with the drums 11A, 11B.

The upper support plate 157 is at the top of the opening 151 held thereat by a threaded stem 158 and a locking member 156, such as a threaded nut with threading which corresponds to the threading on the threaded stem 158. The upper support plate 157 also has a threaded aperture which corresponds to the threading of the threaded stem 158 thereby permitting an operator of the improved apparatus to bring the upper support plate 157 up or down as necessary for the sizes of avocados being processed through the improved apparatus. The locking member 156 threads onto the threaded stem 158 down to the upper support plate 157 to hold the upper support plate 157 there in place.

The present disclosure includes that contained in the present claims as well as that of the foregoing description. Although this presently disclosed apparatus has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the presently described apparatus. Accordingly, the scope of the presently described apparatus should be determined not by the embodiments illustrated, but by the appended claims and their legal equivalents.

What is claimed is:

1. An apparatus for removing skin from an avocado leaving its pulp comprising:
(a) a first drum approximately vertically disposed and rotatable on its axis, said first drum having a plurality of axial grooves with a depth-D1 and corresponding axial peaks having a length-L1 from one axial peak to an adjacent axial peak wherein said plurality of axial grooves are approximately perpendicular to the axis and further having a plurality of cross grooves with a depth-D2 and corresponding cross peaks having a length-L2 from one cross peak to an adjacent cross peak wherein said plurality of cross grooves are approximately parallel to the axis;
(b) a second drum approximately vertically disposed and rotatable on its axis, said second drum having a plurality of axial grooves with a depth-D1 and corresponding axial peaks having a length-L1 from one axial peak to an adjacent axial peak wherein said plurality of axial grooves are approximately perpendicular to the axis and further having a plurality of cross grooves with a depth-D2 and corresponding cross peaks having a length-L2 from one cross peak to an adjacent cross peak wherein said plurality of cross grooves are approximately parallel to the axis, said second drum adjacent to said first drum defining a pair of rotatable drums and a drum gap therebetween;
(c) registration means for aligning an avocado for disposition into said drum gap; and
(d) input means for conveying an avocado to said registration means and forcing said avocado into said drum gap and onto said pair of rotatable drums;
whereby as said first drum and said second drum rotate inward toward said drum gap they pinch the skin of the avocado forcing the skin off the avocado and through said drum gap while permitting virtually all of the pulp as a whole to drop.

2. The apparatus as claimed in claim 1 wherein depth-D1 bears a ratio to length-L1 of approximately 1:3.

3. The apparatus as claimed in claim 1 wherein said depth-D1 is greater than said depth-D2 and said length-L1 is approximately equal to said length-L2.

4. The apparatus as claimed in claim 1 wherein said depth-D1 and said depth-D2 range from approximately 0.020 inches deep to approximately 0.080 inches deep.

5. The apparatus as claimed in claim 1 wherein said depth-D1 is approximately 0.034 inches deep to approximately 0.035 inches deep and said depth-D2 is approximately 0.033 inches deep.

6. The apparatus as claimed in claim 1 wherein each one of said axial peaks and each adjacent one of said cross peaks of said first drum and said second drum share a termination point.

7. The apparatus as claimed in claim 1 wherein said length-L1 and said length-L2 ranges from approximately 0.060 inches to approximately 0.250 inches.

8. The apparatus as claimed in claim 1 wherein said length-L1 and said length-L2 each are approximately 0.110 inches.

9. The apparatus as claimed in claim 1 wherein said registration means comprises a guide plate comprising:
(a) attachment means for attaching said guide plate to said apparatus;
(b) receiving means for receiving said avocado and passing said avocado through said guide plate to said pair of rotatable drums;
(c) a left side member having a top, a bottom, a near edge and a far edge biasedly attached at said near edge to a left side of said guide plate biasing to contact one of said pair of rotatable drums and a right side member having a top, a bottom, a near edge and a far edge biasedly attached at said near edge to a right side of said guide plate biasing to contact another one of said pair of rotatable drums, wherein said far edge of each of said left side member and said right side member is an angled edge and has ends which correspond to said plurality of axial grooves of said pair of rotatable drums and by such contact scrape residue pulp from said pair of rotatable drums.

10. An apparatus for removing skin from an avocado leaving its pulp comprising:
(a) a first drum and a second drum each approximately vertically disposed and rotatable on its respective axis, said second drum adjacent to said first drum defining a pair of rotatable drums and a drum gap therebetween;
(b) a guide plate comprising attachment means for attaching said guide plate to said apparatus; receiving means for receiving said avocado and passing said avocado through said guide plate to said pair of rotatable drums; a left side member with a top, a bottom, a near edge and a far edge biasedly attached at said near edge to a left side of said guide plate biasing to contact one of said pair of rotatable drums; and a right side member with a top, a bottom, a near edge and a far edge biasedly attached at said near edge to a right side of said guide plate biasing to contact another one of said pair of rotatable drums, wherein said far edge of each of said left side member and said right side member is an angled edge; and
(c) input means for conveying an avocado to said guide plate and forcing said avocado into said drum gap and onto said pair of rotatable drums;
whereby as said first drum and said second drum rotate inward toward said drum gap they pinch the skin of the avocado forcing the skin off the avocado and through said drum gap while permitting virtually all of the pulp as a whole to drop and said far edge of each of said left side member and of said right side member scrape residue pulp from said pair of rotatable drums.

11. The apparatus as claimed in claim 10 wherein said first drum and said second drum each have a plurality of axial grooves with a depth-D1 and corresponding axial peaks having a length-L1 from one axial peak to an adjacent axial peak wherein said plurality of axial grooves are approximately perpendicular to the axis and further having a plurality of cross grooves with a depth-D2 and corresponding cross peaks having a length-L2 from one cross peak to an adjacent cross peak wherein said plurality of cross grooves are approximately parallel to the axis.

12. The apparatus as claimed in claim 11 wherein depth-D1 bears a ratio to length-L1 of approximately 1:3.

13. The apparatus as claimed in claim 11 wherein said angled edge of said right side member and of said left side member each have ends which correspond to said plurality of axial grooves of said pair of rotatable drums and by such configuration engage a greater surface of said plurality of axial grooves on contact to scrape residue pulp from said pair of rotatable drums.

14. The apparatus as claimed in claim 11 wherein said depth-D1 is greater than said depth-D2 and said length-L1 is approximately equal to said length-L2.

15. The apparatus as claimed in claim 11 wherein said depth-D1 and said depth-D2 range from approximately 0.020 inches deep to approximately 0.080 inches deep.

16. The apparatus as claimed in claim 11 wherein said depth-D1 is approximately 0.034 inches deep to approximately 0.035 inches deep and said depth-D2 is approximately 0.033 inches deep.

17. The apparatus as claimed in claim 11 wherein each one of said axial peaks and each adjacent one of said cross peaks of said first drum and said second drum share a termination point.

18. The apparatus as claimed in claim 11 wherein said length-L1 and said length-L2 ranges from approximately 0.060 inches to approximately 0.250 inches.

19. The apparatus as claimed in claim 11 wherein said length-L1 and said length-L2 each are approximately 0.110 inches.
